(19) United States
(12) Patent Application Publication
(10) Pub. No.: US 2010/0239878 A1
(43) Pub. Date: Sep. 23, 2010

(54) METHOD OF MANUFACTURING PERMANENT MAGNET AND PERMANENT MAGNET

(76) Inventors: Hiroshi Nagata, Ibaraki (JP); Yoshinori Shingaki, Ibaraki (JP); Kazutoshi Takahashi, Chiba (JP); Yasuo Nakadai, Chiba (JP)

Correspondence Address: Tomoko Nakajima;Cermak Nakajima LLP, 127 S. Peyton Street, Suite 210, Alexandria, VA, 22314, US

(21) Appl. No.: 12/679,623

(22) PCT Filed: Oct. 28, 2008
(86) PCT No.: PCT/JP2008/069548

§ 371 Date: May 5, 2010

(30) Foreign Application Priority Data
Oct. 31, 2007 (JP) 2007-284311
Feb. 22, 2008 (JP) 2008-041556

(51) Int. Cl. B32B 15/02; B05D 5/00

(52) U.S. Cl. 428/548; 427/127

(57) ABSTRACT

High-performance magnets are obtained by: housing metal evaporating materials (v) containing at least one of Dy and Tb and sintered magnets (S) inside a processing box; disposing the processing box inside a vacuum chamber; thereafter, heating the processing box to a predetermined temperature in a vacuum atmosphere to thereby evaporate the metal evaporating materials and cause them to be adhered to the sintered magnets. The metal atoms of the adhered Dy or Tb are diffused into grain boundaries and/or grain boundary phases of the sintered magnets. A method of manufacturing a permanent magnet is provided in which, even if the sintered magnets and the metal evaporating materials are disposed in close proximity to each other, the squareness of demagnetization curve is not impaired and in which high feasibility of mass production can be attained. While the metal evaporating materials are being evaporated, an inert gas is introduced into the processing chamber in which the sintered magnets are disposed.

### TECHNICAL FIELD

The present invention relates to a method of manufacturing a permanent magnet and also relates to a permanent magnet. In particular, this invention relates to a method of manufacturing a high-performance magnet in which Dy or Tb is diffused only in the grain boundaries and/or grain boundary phases of a Nd—Fe—B based sintered magnet, and relates to a permanent magnet to be manufactured by this method of manufacturing.

### BACKGROUND ART

A Nd—Fe—B based sintered magnet (so-called neodymium magnet) can be manufactured at a low cost by a combination of iron and such elements of Nd and B as are inexpensive, abundant as natural resources, and stably obtainable, and additionally has high magnetic properties (its maximum energy product is about 10 times that of a ferritic magnet). Accordingly, the Nd—Fe—B based sintered magnets have been used in various kinds of products such as electronic devices and have recently come to be employed in motors and electric generators for hybrid cars, and the amount of use is on the increase.

Since the Curie temperature of the above-described sintered magnet is as low as about 300° C., there is a case in which the sintered magnet sometimes rises in temperature beyond a predetermined temperature depending on the way how the product in which the sintered magnet is employed is put to use. If the predetermined temperature is exceeded, there is a problem in that the sintered magnet will be demagnetized by heat. In addition, when the above-described sintered magnet is put into actual use as a desired product after manufacturing it, there are cases where the sintered magnet is machined into a predetermined shape. This machining gives rise to defects (cracks and the like) and strains in the crystal grains that are present near the surface of the sintered magnet. As a result, deterioration through machining takes place (layer deteriorated by machining will be formed), and flux reversal easily comes to take place. As a consequence, there is another problem in that the magnetic properties are remarkably deteriorated such as the lowering in the coercive force.

Therefore, the following is known in the art, namely, a rare earth metal selected from Yb, Eu and Sm is disposed in a processing chamber in a state of being mixed with a Nd—Fe—B based sintered magnet. By heating the processing chamber, the rare earth metal is evaporated, and the evaporated rare earth metal atoms are caused to be sorbed into the sintered magnet. The metal atoms are further diffused into the grain boundary phases of the sintered magnet. In this manner, the rare earth metal is introduced into the surface and into the grain boundary phases of the sintered magnet uniformly and in a desired amount, whereby the magnetizing force and coercive force are improved or recovered (see Patent Document 1).

It is to be noted here that, among the rare earth metals, Dy and Tb have magnetic anisotropy of 4f electrons larger than that of Nd and have a negative Stevens factor like Nd does. Therefore, Dy and Tb are known to largely improve the magnetocrystalline anisotropy of the main phase. However, if Dy or Tb is added at the time of manufacturing a sintered magnet, since Dy and Tb take a ferrimagnetism structure having a spin orientation opposite to that of Nd in the crystal lattice of the main phase, the magnetic field strength and consequently the maximum energy product exhibiting the magnetic properties are largely lowered.

As a solution, it is proposed, by using Dy or Tb, to introduce a uniform and desired amount of Dy or Tb into the grain boundaries and/or grain boundary phases in the above-described method. However, if metal atoms of evaporated Dy or Tb are supplied so that, by using the above-described method, Dy or Tb is present also on the surface of the sintered magnet (i.e., so that a thin film of Dy or Tb is formed on the surface of the sintered magnet), a problem occurs in that the metal atoms deposited on the surface of the sintered magnet will be re-crystallized, thereby remarkably deteriorating the surface of the sintered magnet (surface roughness becomes poor). In the above-described method in which the rare earth metal and the sintered magnet are disposed in a mixed state, the rare earth metal that is molten at the time of heating a metal evaporating material gets directly adhered to the sintered magnet. As a result, the formation of a thin film and the formation of projections cannot be avoided.

In addition, if the metal atoms are excessively supplied to the surface of the sintered magnet so as to form a thin film of Dy or Tb on the surface of the sintered magnet, the metal atoms get deposited on the surface of the sintered magnet that is being heated during the processing. As a result of an increase in the amount of Dy or Tb, the melting point in the neighborhood of the surface will lower. Consequently, Dy or Tb deposited on the surface will get molten so as to get penetated excessively into the grain boundaries, particularly near the surface of the sintered magnet. In case of an excessive penetration into the grain boundaries, Dy or Tb takes a ferrimagnetism structure having a spin orientation opposite to that of Nd in the crystal lattice of the main phase, as described above. There is therefore a possibility that the magnetizing force and coercive force cannot effectively be improved or recovered.

In other words, once a thin film of Dy or Tb has been formed on the surface of the sintered magnet, an average composition on the surface of the sintered magnet adjacent to the thin film becomes a rare-earth-rich composition of Dy or Tb. Once a rare-earth-rich composition has been formed, the liquid-phase temperature becomes lower and the surface of the sintered magnet comes to be molten (i.e., the main phase gets molten and the amount of liquid phase increases). As a result, the sintered magnet becomes molten and gets out of shape in the neighborhood of the surface thereof, resulting in an increase in projections and recessions. In addition, together with a large amount of liquid phase, Dy excessively gets penetrated into the crystal grains, thereby further lowering the maximum energy product and the remanent flux density exhibiting the magnetic properties.

As a solution to this kind of problem, it has been proposed by the applicants of this patent application to carry out a processing (vacuum vapor processing) by: housing an iron-boron-rare earth based sintered magnet and a metal evaporating material containing at least one of Dy and Tb, inside a processing box at a spacing from each other; heating the processing box in a vacuum atmosphere to thereby evaporate the metal evaporating material; adjusting the amount of supply of thus evaporated metal atoms to the surface of the sintered magnet so as to cause the metal atoms to get adhered thereto; and diffusing the adhered metal atoms into the grain boundaries and/or the grain boundary phases of the sintered magnet so that a thin film made from the metal evaporating material is not formed on the surface of the sintered magnet (International application PCT/JP2007/066272).

Patent Document 1: JP-A-2004-296973 (see, e.g., descriptions in the claims)

### DISCLOSURE OF THE INVENTION

### Problems to be Solved by the Invention

According to the above-described vacuum vapor processing, the surface state of the permanent magnet after the processing remains substantially the same as the state before processing and does not require a particular post-processing. In addition, since Dy or Tb is diffused so as to be uniformly spread into the grain boundaries and/or grain boundary phases of the sintered magnet, the grain boundaries and/or grain boundary phases have a Dy-rich or Tb-rich phase (a phase containing Dy or Tb in the range of 5˜80%). Further, Dy or Tb gets diffused only into the neighborhood of the surfaces of the crystal grains and, as a result, there can be obtained a high-performance magnet in which the magnetizing force and the coercive force have effectively been improved or recovered.

Further, by evacuating the processing chamber having disposed therein the sintered magnet down to a high vacuum (10⁻⁴ P) to thereby carry out the above-described vacuum vapor processing, there can be obtained a high-performance magnet having an extremely high corrosion resistance and high weather resistance without the necessity of a protective layer of Ni plating. This obtaining is due to a combined effect in: that the impurities such as oxygen and the like get hardly taken into the surface of the sintered magnet; and that Dy-rich phase is formed in the cracks generated, at the time of machining, in the crystal grains which are the main phases on the surface of the sintered magnet.

However, it has been found out that, unless the sintered magnet and the metal evaporating material are disposed at a predetermined spacing from each other inside the processing box, they will be strongly influenced by the rectilinear properties of the evaporated metal atoms. In other words, in case the sintered magnet is placed on a bearing grid (mounting table) which is made by assembling a small-diameter wire material into a lattice shape, if the above-described spacing is small, the metal atoms are likely to be locally adhered, out of the entire sintered magnet, to the surface which lies opposite to the metal evaporating material. Further, the Dy or Tb becomes hardly supplied to the portions which are shaded by the wire material. Therefore, the permanent magnet that has been subjected to the above-described vacuum vapor processing will have a portion of locally high coercive force and a locally low coercive force and, as a result, the squareness of the demagnetization curve will be impaired. On the other hand, if the spacing between the sintered magnet and the metal evaporating material is made large inside the processing box, the number of the sintered magnets that can be processed in a single processing box is limited, whereby a high feasibility for mass-production cannot be obtained.

In view of the above points, this invention has a problem of providing a method of manufacturing a permanent magnet and providing a permanent magnet manufactured by this method in which, even in case the sintered magnet and the metal evaporating material are disposed in close proximity to each other, the squareness of the demagnetization curve is not impaired and in which a high feasibility for mass-production can be attained.

### Means for Solving the Problems

In order to solve the above problems, the method of manufacturing a permanent magnet comprises: heating an iron-boron-rare earth based sintered magnet disposed in a processing chamber to a predetermined temperature, and also evaporating a metal evaporating material containing at least one of Dy and Tb, the metal evaporating material being disposed in the same or another processing chamber; adjusting a supply amount of thus evaporated metal atoms to a surface of the sintered magnet to adhere the metal atoms to the sintered magnet, and diffusing the adhered metal atoms into grain boundaries and/or grain boundary phases of the sintered magnet. An inert gas is introduced into the processing chamber in which the sintered magnet is disposed, the inert gas being introduced while the metal evaporating material is being evaporated.

According to this invention, while the metal evaporating material is being evaporated, the inert gas is introduced into the processing chamber in which the sintered magnet is disposed. Because the mean free path of the metal atoms, e.g., of Dy or Tb is short, the metal atoms evaporated in the processing chamber will be diffused by the inert gas. As a result, the metal atoms that will be directly adhered to the surface of the sintered magnet will be reduced in amount and, at the same time, will be supplied to the surface of the sintered magnet from a plurality of directions. Therefore, even in case the spacing between the sintered magnet and the metal evaporating material is small, the evaporated Dy or Tb will wrap around even the portions which are shaded by the wire material and get adhered thereto. In consequence, it is possible to restrain the metal atoms of Dy or Tb from getting excessively diffused into the crystal grains, the excessive diffusion resulting in a decrease in the maximum energy product and the remanent magnetic flux density. It is also possible to restrain the presence of portions of locally high coercive force and locally low coercive force. The squareness of the demagnetization curve can thus be prevented from getting impaired. In addition, the spacing between the sintered magnet and the metal evaporating material inside the processing chamber can be minimized to enable them to be disposed in close proximity to each other in both the up and down direction and the right and left direction. As a result, the amount of mounting of the sintered magnets in a single processing chamber can be increased, thereby attaining a high feasibility of mass productivity.

In the invention, in a step of heating the sintered magnet to reach the predetermined temperature, the pressure in the processing chamber in which the sintered magnet is disposed, is maintained at 0.1 Pa or less, preferably at 10⁻² Pa or less, and more preferably at 10⁻⁴ Pa or less before the inert gas is introduced. Thus, there is no possibility that the impurities such as oxygen and the like are taken into the sintered magnet. As a result, there can be attained a further improvement or recovery of the magnetizing force and the coercive force.

In the invention, preferably a partial pressure of the inert gas is varied to adjust the supply amount.

In this case, the partial pressure of the inert gas in the processing chamber shall preferably be in a range of 1˜30 kPa. At a pressure below 1 kPa, the squareness of the demagnetization curve will be impaired under the influence of the strong rectilinear properties of the metal evaporating material. At a pressure exceeding 30 kPa, on the other hand, the inert gas will make it difficult for the metal atoms to be sufficiently supplied to the surface of the sintered magnet.

In addition, in order to obtain a high-performance magnet which is superior in mass-productivity by causing the metal atoms adhered to the surface of the sintered magnet, to be diffused and uniformly spread into the grain boundaries and/or grain boundary phases before a thin film made of the metal evaporating material is formed, the time of adjusting the supply amount shall preferably be in a range of 4˜100 hours. In a time shorter than 4 hours, the metal atoms cannot be efficiently diffused into the grain boundaries and/or grain boundary phases of the sintered magnet, whereby the squareness of the demagnetization curve is impaired. In a time exceeding 100 hours, on the other hand, the metal atoms will be penetrated into the crystal grains near the surface of the sintered magnet. As a result, there will be present portions of locally high coercive force and of locally low coercive force, whereby the squareness of the demagnetization curve will also be impaired in a similar manner as in the above.

Further, according to this invention, when the spacing between the sintered magnet and the metal evaporating material is minimized in order to increase the amount of mounting, it is necessary to prevent the metal evaporating material from getting directly adhered to the sintered magnet when the metal evaporating material is evaporated. For this purpose, when the sintered magnet and the metal evaporating material are disposed in the same processing chamber, the sintered magnet and the metal evaporating material shall be disposed free from contact with each other.

In this case, the spacing between the sintered magnet and the metal evaporating material shall preferably be set to a range of 0.3˜10 mm, more preferably to a range of 0.3˜2 mm. According to this arrangement, the magnetic force and the coercive force are further improved or recovered. In addition, there can be obtained with good productivity a high-performance magnet whose squareness of the demagnetization curve is not impaired.

After having diffused the metal atoms into the grain boundary phases of the sintered magnet, heat treatment is preferably carried out at a given temperature which is lower than the said predetermined temperature. The magnetic properties can advantageously be further improved.

Further, in order to solve the above-described problems, according to another aspect of this invention, there is provided a permanent magnet manufactured by using the method of manufacturing a permanent magnet according to any one of claims 1 through 7. In the permanent magnet the metal atoms are distributed into the grain boundaries and/or grain boundary phases in concentration which becomes thinner from the surface of the magnet toward the center thereof. Further, the metal atoms of at least one of Dy and Tb are uniformly present on the surface of the magnet (in other words, there exists no metal-atom-enriched region of Dy or Tb on the surface thereof), and an oxygen concentration is uniform (in other words, there exists no locally oxygen-enriched portion).

### BEST MODE FOR CARRYING OUT THE INVENTION

Description will be made with reference to FIG. 1. In an embodiment of this invention, permanent magnets M are manufactured by carrying out, at the same time, a series of operations (vacuum vapor processing) of evaporating metal evaporating materials v toward the surfaces of Nd—Fe—B based sintered magnets S that have been manufactured into a predetermined shape; causing the evaporated metal atoms to get adhered to the surfaces, and diffusing the metal atoms into the grain boundaries and/or grain boundary phases of the sintered magnets S.

The Nd—Fe—B based sintered magnets S, which are starting materials, are manufactured in the following manner, namely, pure iron for industrial use, metal neodymium, and low-carbon ferroboron are mixed so that Fe, Nd and B attain a predetermined composition ratio, and the mixture is melted by using a vacuum induction furnace. Then, by a rapid quenching method, e.g., by strip-casting method, an alloy raw material of 0.05˜0.5 mm is manufactured first. Alternatively, an alloy raw material of about 5˜10 mm thick may be manufactured by a centrifugal casting method. Or else, at the time of mixing, Dy, Tb, Co, Cu, Nb, Zr, Al, Ga and the like may be added. A total content of the rare earth elements shall be made higher than 28.5% so as to obtain an ingot in which alpha iron is not formed.

Then, the alloy raw material thus manufactured is subjected to coarse grinding by hydrogen grinding process known in the art, and is subsequently subjected to fine grinding in a nitrogen gas atmosphere by a jet mill fine grinding process to thereby obtain an alloy raw meal with an average particle size of 3˜10 μm. This alloy raw meal is molded into a predetermined shape by compression in a magnetic field by using a compression molding machine known in the art. The molded body taken out of the compression molding machine is housed into a sintering furnace (not illustrated) and is subjected to sintering (sintering step) for a predetermined period of time at a predetermined temperature (e.g., 1050° C.), thereby obtaining a primary sintered body.

Then, the primary sintered body thus manufactured is housed into a vacuum heat treatment furnace (not illustrated) to thereby heat it to a predetermined temperature in a vacuum atmosphere. The heating temperature shall be set to a temperature which is above 900° C. but is below a sintering temperature. At a temperature below 900° C., the speed of evaporation of the rare earth elements is low and, at a temperature exceeding the sintering temperature, an abnormal particle growth will take place, thereby resulting in a large lowering in the magnetic properties. The pressure inside the furnace is set to a pressure below 10⁻³ Pa. At a pressure above 10⁻³ Pa, the rare-earth elements cannot be efficiently evaporated.

According to the above, due to the difference in vapor pressure at a constant temperature (e.g., at 1000° C., the vapor pressure of Nd is 10⁻³ Pa, the vapor pressure of Fe is 10⁻⁵ Pa, and the vapor pressure of B is 10⁻¹³ Pa), only the rare earth elements in the rare-earth-rich phase of the primary sintered body will be evaporated. As a result, the proportion of the Nd-rich phase will decrease, and there will be manufactured a sintered magnet S in which the maximum energy product ((BH)max) and the remanent flux density (Br) are improved. In this case, in order to obtain a high-performance permanent magnet M, heat treatment is carried out until the content of the rare earth element R in the permanent magnet becomes less than 28.5 wt % or the amount of decrease in an average concentration of the rare earth element R becomes more than 0.5 wt %. The sintered magnet S thus obtained is subjected to vacuum vapor processing. With reference to FIG. 2, a description will now be made of a vacuum vapor processing apparatus for carrying out this vacuum vapor processing.

A vacuum vapor processing apparatus 1 has a vacuum chamber 3 which is capable of reducing the pressure down a predetermined pressure (e.g., 1×10⁻⁵ Pa) by means of an evacuating means 2 such as a turbo-molecular pump, cryo-pump, diffusion pump, and the like, and which is capable of maintaining the vacuum chamber at that pressure. The vacuum chamber 3 is provided therein with a heating means 4 constituted by: an insulating material (a heat insulating material) 41 which encloses the periphery of a processing box (to be described hereinafter); and a heat generating body 42 which is disposed on the inside of the insulating material. The insulating material 41 is made, e.g., of Mo, and the heat generating body 42 is an electric heater having a filament (not illustrated) of Mo make. By passing electric current from a power source (not illustrated) through the filament, it is possible to heat a space 5 which is of electric resistance heating type, enclosed by the insulating material 41, and in which is disposed the processing box. This space 5 is provided with a mounting table 6, e.g., of Mo make so that at least one processing box 7 can be mounted thereon.

The processing box 7 is constituted by a rectangular parallelepiped box portion 71 which is open on an upper surface, and a lid portion 72 which is detachably mounted on the upper surface of the opened box portion 71. Along an entire peripheral edge of the lid portion 72, there is formed a flange 72a which is bent downward. When the lid portion 72 is mounted in position on the upper surface of the box portion 71, the flange 72a gets engaged with an outer wall of the box portion 71 (in this case, there is provided no vacuum sealing such as a metallic seal). As a result, there is defined a processing chamber 70 which is isolated from the vacuum chamber 3. Then, when the vacuum chamber 3 is evacuated down to a predetermined pressure (e.g., 1×10⁻⁵ Pa) by operating the evacuating means 2, the processing chamber 70 will be reduced in pressure to a substantially half-digit higher pressure (e.g., 5×10⁻⁴ Pa) than the pressure in the vacuum chamber 3. According to this arrangement, the processing chamber 70 can be reduced to a predetermined vacuum pressure without the need for an additional evacuating means.

As shown in FIG. 3, in the box portion 71 of the processing box 7, there are housed therein the above-described sintered magnets S and metal evaporating materials v in a vertically stacked manner respectively with spacers 8 interposed therebetween to prevent them from getting into contact with each other. Each of the spacers 8 is constituted into a lattice shape by assembling a plurality of wire materials 81 (e.g., Φ0.1˜10 mm) in a manner to become smaller in area than the cross-sectional surface of the box portion 71, and each of the peripheral edge portions is bent upward substantially at right angles. The height of the bent portions is set to be higher than the height of the sintered magnets S to be subjected to vacuum vapor processing. In this embodiment, the bent peripheral edge portions constitute supporting pieces 9 which secure space to the metal evaporating materials v to be disposed on an upper side thereof. A plurality of sintered magnets S are disposed on the horizontal portions of the spacers 8 at an equal spacing from one another.

It is preferable to set the height of the supporting pieces 9 such that the vertical spacing between the sintered magnets S and the metal evaporating materials v falls within a range of 0.3˜10 mm, more preferably of 0.3˜2 mm. According to this arrangement, there can be obtained, at a good productivity, high-performance magnets in which: the Dy atoms can ideally be supplied; the magnetizing force and coercive force are further improved or recovered; and the squareness of demagnetization curve is not impaired. Alternatively, in addition to, or in place of, the supporting pieces 9, there may be employed an arrangement in which height-adjusting jigs (not illustrated) of solid cylindrical bodies of Mo make are vertically disposed between the metal evaporating materials v and the horizontal portions of the spacers 8, whereby the above-described spacing is adjusted.

As the metal evaporating materials v, there are used Dy and Tb which largely improve the crystal magnetic anisotropy of the main phase, or an alloy which is obtained by mixing metals for further increasing the coercivity such as Nd, Pr, Al, Cu, Ga and the like into Dy and Tb (mass ratio of Dy or Tb is above 50%). After mixing each of the above-described metals in a predetermined mixing ratio, the mixture is melted in, e.g., an electric arc furnace, and is then formed into a plate shape of a predetermined thickness. In this case, the metal evaporating materials v have an area sufficient to be supported by an entire circumference of the supporting pieces 9.

After disposing the plate-shaped metal evaporating material v on the bottom surface of the box portion 71, there is placed on the upper side thereof a spacer 8 on which the sintered magnets S are placed in position. Further, another plate-shaped metal evaporating material v is placed so as to be supported by the upper ends of the supporting pieces 9. In this manner, the metal evaporating materials v and the spacers 8 each having placed in position thereon a plurality of sintered magnets S are alternately stacked with each other into layers up to the upper end portion of the processing box 7. Above the uppermost spacer 8 the lid portion 72 is positioned close thereto. Therefore, the metal evaporating materials v may be omitted.

According to this arrangement, by increasing the number of sintered magnets S to be housed inside a single processing box 7 (the amount of mounting increases), feasibility for mass production can be increased. In addition, according to this embodiment, there has been employed by a so-called sandwich structure in which the upper side and the lower side of the sintered magnets S that are placed in parallel with one another on the spacer 8 (on the same plane) are sandwiched by the plate-shaped metal evaporating materials v. Therefore, the metal evaporating materials v are positioned in close proximity to all of the sintered magnets S inside the processing chamber 70. As a result, when the metal evaporating materials v are evaporated, the evaporated metal atoms come to be supplied and adhered to the surfaces of the respective sintered magnets S. Consequently, there is no impairing of the effect of vacuum vapor processing in that, by diffusing the Dy or Tb atoms into the grain boundaries and/or grain boundary phases of the sintered magnets, the magnetic force and coercive force are improved or recovered. In addition, only by stacking the spacers 8 and the plate-like metal evaporating materials v, there can be secured a predetermined space between the metal evaporating materials v to be stacked right above the sintered magnets S and the sintered magnets S, thereby preventing them from coming into contact with each other. In this manner, the workability can be improved in housing the metal evaporating materials v and the sintered magnets S into the processing box 7.

The processing box 7 and the spacers 8 may be manufactured not only in Mo, but also in W, V, Nb, Ta or an alloy thereof (inclusive of a rare-earth-added type of Mo alloy, Ti-added type of Mo alloy, and the like), or in CaO, Y₂O₃, or may otherwise be manufactured in rare-earth oxides. Or else, the processing box 7 and the spacers 8 may be constituted by forming a film of the above-described material(s) as an inner lining on the surface of another insulating material. According to this arrangement, reaction products through reaction with Dy or Tb can advantageously be prevented from being formed on the surface thereof.

Further, in case the metal evaporating materials v are evaporated in a state in which the metal evaporating materials v and the sintered magnets S are stacked in a vertical direction in a sandwiched structure inside the processing box 7 as described above, the sintered magnets S will be largely affected by the rectilinear properties of the evaporated metal atoms. In other words, among the sintered magnets S, the metal atoms are likely to get adhered locally to those surfaces of the sintered magnets S which lie opposite to the metal evaporating materials v. In addition, Dy or Tb is likely to be hardly supplied to the portions that are shaded at the surfaces of contact of the sintered magnets S with the spacers 8. Therefore, when the above-described vacuum vapor processing is carried out, the sintered magnets S thus obtained will have portions with locally higher coercive force and portions with locally lower coercive force. As a result, the squareness of the demagnetization curve will be impaired.

In the embodiment of this invention, the vacuum chamber 3 is provided with an inert gas introduction means. The inert gas introduction means has a gas introduction pipe 10 which is communicated with the space 5 enclosed by the section material 41. The gas introduction pipe 10 is in communication with a gas source for an inert gas through a massflow controller (not illustrated). During the time of the vacuum vapor processing operation, an inert gas such as He, Ar, Ne, Kr and the like is arranged to be introduced in a constant amount. It may be so arranged that the amount of introduction of the inert gas is varied in the course of the vacuum vapor processing (i.e., the amount of introduction of the inert gas is increased at the beginning and is subsequently decreased, or else, the amount of introduction of the inert gas is decreased at the beginning and is subsequently increased, or the above-described operations are repeated). The introduction of the inert gas may take place, e.g., after the beginning of evaporation of the metal evaporating materials v or after a set heating temperature has been reached. The introduction may continue during a set time of the vacuum vapor processing or during a predetermined period of time before and after the above-described time of the vacuum vapor processing. It is preferable to provide an evacuating pipe communicated with the evacuating means 2, with a valve 11 which is adjustable in its opening degree so that, when the inert gas is introduced, the partial pressure of the inert gas inside the vacuum chamber 3 can be adjusted.

According to this arrangement, the inert gas that is introduced into the space 5 is also introduced into the processing box 7. At this time, since the mean free paths of the metal atoms of Dy or Tb are short, the evaporated metal atoms will be diffused by the inert gas inside the processing box 7. The amount of metal atoms to be adhered directly to the surfaces of the sintered magnets S will therefore decrease, and also the metal atoms come to be supplied to the surfaces of the sintered magnets S from a plurality of directions. Therefore, even in case the spacing between the sintered magnets S and the metal evaporating materials v is small (e.g., 5 mm or less), the evaporated Dy or Tb will be adhered even to those portions which are shaded by the wire materials 81, by wrapping around the shaded portions. As a result, there can be prevented the metal atoms of Dy or Tb from excessively diffusing into the crystal grains and also the maximum energy product and the remanent magnetic flux density from being lowered. In addition, the presence of locally high coercive force and locally low coercive force can be reduced, thereby preventing the squareness of the demagnetization curve from getting impaired.

With reference to FIG. 4, a description will now be made of a method of manufacturing a permanent magnet according to the embodiment of this invention which is carried out by using Dy as the metal evaporating materials v, and by going through each of the steps of a heating step, a vapor processing step, and an annealing step.

First, as described hereinabove, by alternately stacking the sintered magnets S and the metal evaporating materials v via spacers 8 therebetween, they are first disposed in the box portion 71 (as a result, the sintered magnets S and the metal evaporating materials v are disposed in position inside the processing chamber 70 at a spacing in a range of 0.3˜10 mm, more preferably of 0.3˜2 mm, as seen in the vertical direction). Then, after having mounted the lid portion 72 on the upper surface of the box portion 71, the processing box 7 is mounted in position on the table 6 in the space 5 enclosed by the heating means 4 within the vacuum chamber 3 (see FIG. 2), and the heating step is started.

In the heating step, the vacuum chamber 3 is reduced in pressure by evacuating it until it reaches a predetermined pressure (e.g., 1×10⁻⁴ Pa) by means of the evacuating means 2 (the processing chamber 70 is evacuated to a pressure which is higher by about half a digit than that of the vacuum chamber). When the vacuum chamber 3 has reached the predetermined pressure, the heating means 4 is operated to thereby heat the processing chamber 70. In this state the pressures inside the vacuum chamber 3 and the processing chamber 70 are substantially constant. Further, by maintaining constant the evacuating speed of the evacuating means 2, or by a similar operation, the pressure inside the processing chamber 70 is maintained below 0.1 Pa, preferably below 10⁻² Pa, and more preferably below 10⁻⁴ Pa (see FIG. 4, portion A). In this case, there are cases where the pressure becomes higher due, e.g., to the emission gases from the sintered magnets S. However, as described below, it is acceptable if about 70% out of the time until the inert gas begins to be introduced, falls within the above-described pressure range. According to this arrangement, impurities such as oxygen and the like are hardly taken into the sintered magnets S, thereby further improving or recovering the magnetic force and coercive force.

Once the temperature inside the processing chamber 70 reaches a predetermined temperature, Dy in the processing chamber 70 will be heated to substantially the same temperature as the processing chamber 70. As a result, evaporation of the Dy will start and a Dy vapor atmosphere will be formed inside the processing chamber 70. Therefore, an inert gas of 1˜100 kPa is introduced before reaching the evaporation temperature, thereby restricting the evaporation of Dy.

Then, when the temperature inside the processing chamber 70 reaches the predetermined temperature after the starting of the evaporation of Dy, the opening degree of the valve 11 is adjusted to thereby adjust the pressure of the inert gas inside the vacuum chamber 3. At this time, the inert gas is introduced also into the processing box 7, so that the metal atoms evaporated inside the processing chamber 70 are diffused by the inert gas.

Since an arrangement has been made such that the sintered magnets S and the Dy do not come into contact with each other, even in case Dy starts evaporation, the melted Dy will not directly get adhered to the sintered magnets S whose Nd-rich phase on the surface is melted. Then, the process proceeds to the vacuum processing step in which substantially constant temperature is maintained for a predetermined period of time.

In the vacuum vapor processing step, those Dy atoms in the Dy vapor atmosphere which are diffused inside the processing box 7 are supplied, from a plurality of directions either directly or by repeating collisions, toward substantially the entire surfaces of the sintered magnets S that are heated to substantially the same temperature as Dy, and get adhered thereto. The adhered Dy is diffused into the grain boundaries and/or grain boundary phases of the sintered magnets S, whereby permanent magnets M can be obtained.

Here, once the Dy atoms in the Dy vapor atmosphere are supplied to the surfaces of the sintered magnets S so that Dy layer (thin film) can be formed, the surfaces of the permanent magnets M will be remarkably deteriorated (surface roughness becomes poor) when Dy that has been adhered to, and deposited on, the surfaces of the sintered magnets S, get recrystallized. In addition, Dy that has been adhered to, and deposited on, the surfaces of the sintered magnets S that have been heated to substantially the same temperature during processing, will be melted (resolved) so as to be excessively diffused into the grain boundaries in the region close to the surfaces of the sintered magnets S. As a consequence, the magnetic properties cannot be effectively improved or recovered.

In other words, once the thin film of Dy has been formed on the surfaces of the sintered magnets S, the average composition of the surfaces of the sintered magnets S adjacent to the thin film becomes a Dy-rich composition. Once the Dy-rich composition has been formed, the liquid phase temperature lowers and the surfaces of the sintered magnets S come to be melted (i.e., the main phase is melted and the amount of liquid phase increases). As a result, the neighborhood of the surfaces of the sintered magnets S will be melted and get out of shape, resulting in an increase in projections and recessions. Moreover, Dy is excessively penetrated into the crystal grains together with a large amount of liquid phase. As a result, the maximum energy product and remanent magnetic flux density exhibiting the magnetic properties will further be lowered.

In the embodiment of this invention, when the metal evaporating materials v are Dy, in order to control the amount of evaporation of the Dy, the heating means 4 is controlled in order to set the temperature inside the processing chamber 70 to a range of 800˜1050° C., preferably to a range of 850˜950° C. (e.g., when the temperature inside the processing chamber is 900˜1000° C., the saturated vapor pressure of Dy will be about 1×10^{-2˜1×10}⁻¹ Pa).

If the temperature in the processing chamber 70 (and consequently the temperature of heating the sintered magnets 5) is below 800° C., the speed of diffusion of the Dy atoms adhered to the surfaces of the sintered magnets S, into the grain boundaries and/or the grain boundary phases becomes lower. As a result, the Dy atoms cannot be uniformly diffused into the grain boundaries and/or the grain boundary phases before the thin film is formed on the surfaces of the sintered magnets S. On the other hand, at the temperature above 1050° C., the vapor pressure of Dy becomes high and, therefore, there is a possibility that the Dy atoms in the vapor atmosphere are excessively supplied to the surfaces of the sintered magnets S. In addition, there is a possibility that the Dy is diffused into the crystal grains. If the Dy is diffused into the crystal grains, the magnetization inside the crystal grains will largely be lowered and, therefore, the maximum energy product and the remanent magnetic flux density will further be lowered.

In addition, an arrangement was made such that the partial pressure of the inert gas introduced into the vacuum chamber 3 falls within a range of 1 ˜30 kPa by varying the opening degree of the valve 11. At a pressure below 1 kPa, under the influence of the strong rectilinear properties of Dy, the Dy atoms will get adhered locally to the sintered magnets S, resulting in impairing of the squareness of demagnetization curve. Above 30 kPa, on the other hand, the evaporation of Dy will be restrained by the inert gas, and Dy atoms will not be efficiently supplied to the surfaces of the sintered magnets S, thereby bringing about an excessively longer processing time.

According to the above arrangement, by controlling the amount of evaporation of Dy as a result of adjusting the partial pressure of the inert gas such as Ar and the like, and by diffusing the evaporated Dy atoms in the processing box as a result of introducing the inert gas, there can be attained the effects: of adhering the Dy atoms to the entire surfaces of the sintered magnets S while restricting the amount of supply of the Dy atoms to the sintered magnets S; and of accelerating the speed of diffusion by heating the sintered magnets S in the predetermined temperature range. Due to the above-described combined effects, before the Dy atoms get deposited on the surfaces of the sintered magnets S to thereby form Dy layers (thin films), the Dy atoms adhered to the surfaces of the sintered magnets S can be efficiently diffused into, and uniformly penetrated into, the grain boundaries and/or grain boundary phases of the sintered magnets S (see FIG. 1).

As a result, the surfaces of the permanent magnets M can be prevented from getting deteriorated. Also, the Dy can be prevented from getting excessively diffused into the grain boundaries in the regions near the surfaces of the sintered magnets, and the grain boundary phases have the Dy-rich phase (phase containing Dy in the range of 5˜80%). Further, by diffusing Dy only near the surfaces of the crystal grains, the magnetizing force and the coercive force can be effectively improved or recovered.

Further, by evacuating the processing chamber 70 down to 10⁻⁴ Pa, by maintaining it at the predetermined pressure in the heating step, and by subsequently carrying out the vacuum vapor processing while introducing the inert gas, the impurities such as oxygen and the like come to be hardly taken into the surfaces of the permanent magnets M. The oxygen content in the permanent magnets M is substantially equal to that in the sintered magnets prior to the vacuum vapor processing. There can further be obtained high-performance permanent magnets M which require no finish machining and which are superior in productivity

In addition, even in case where the metal atoms evaporated in the processing box 7 are present in diffused state, and the sintered magnets S are placed in position on the spacers 8 made by assembling small wire materials 81 into a lattice shape, and the spacing between the sintered magnates S and the metal evaporating materials v is small, evaporated Dy or Tb gets wrapped around even to the portions which are shaded by the wire materials 81 and gets adhered thereto. As a result, the presence of portions where coercive force is locally high or locally low can be restrained. Even if the above-described vacuum vapor processing is carried out on the sintered magnets S, the squareness of the demagnetization curve is prevented from getting impaired, whereby a high feasibility for mass production can be attained.

The time for adjusting the amount of supply of Dy atoms to the surfaces of the sintered magnets S shall fall in a range of 4˜100 hours. If the time is shorter than 4 hours, the metal atoms cannot be efficiently diffused into the grain boundaries and/or grain boundary phases of the sintered magnets S, thereby impairing the squareness of the demagnetization curve. If the time is longer than 100 hours, on the other hand, metal atoms will penetrate into the crystal grains in the neighborhood of the surfaces of the sintered magnets. There will thus be generated portions with locally high coercive force and locally low coercive force, thereby impairing the squareness of the demagnetization curve in the same manner as in the above-described case.

Finally, once the processes as described above have been carried out for the predetermined period of time, the process will proceed to an annealing step. In the annealing step, the operation of the heating means 4 is stopped and, also, the introduction of the inert gas by the gas introduction means is stopped once. Subsequently, the inert gas is introduced once again (100 kPa) to stop the evaporation of metal evaporating materials v. According to these operations, the evaporation of Dy is stopped and its supply is stopped. Alternatively, without stopping the introduction of the inert gas, only the amount of its introduction may be increased so as to stop the evaporation. Then, the temperature inside the processing chamber 70 is once lowered to, e.g., 500° C. Subsequently, the heating means 4 is operated once again. By setting the temperature inside the processing chamber 70 to a range of 450˜650° C., heat treatment is carried out in order to further improve or recover the coercive force. Then, after being quenched to substantially the room temperature, the processing box 7 is taken out of the vacuum chamber 3.

FIG. 5 show SEM micrographs and EPMA micrographs (color mapping analyses of Ni element, P element, Nd element, Fe element, Dy element and oxygen element) in the neighborhood of the surfaces of the permanent magnets (product of this invention) in which the above-described vacuum vapor processing is carried out on the sintered magnets S, and in which Ni plating layer was formed on each of the surfaces of the permanent magnets. FIG. 6 is a graph showing the result of line analysis of Dy distribution from the surface of the magnet toward the center thereof.

According to the above, in the case of the magnets (prior art products) in which, after once having formed a Dy film by the sputtering method and the like as in the prior art, semi-products thus obtained were subjected to heat treatment to thereby diffuse the Dy into the grain boundaries and/or grain boundary phases, there will always remain a Dy-enriched layer on the surfaces of the magnets. In the case of the product of this invention, on the other hand, it can be seen: that there does not exist, on the surface of the magnets, a layer in which Dy is enriched (i.e., Dy concentration becomes uniform); that, before the thin film made from Dy is formed, Dy gets diffused into the grain boundaries and/or grain boundary phases; and that the Dy atoms are uniformly diffused into the grain boundaries and/or grain boundary phases such that the concentration of content becomes thinner from the surfaces of the magnets toward the center thereof (see FIG. 5(f) and FIG. 6). In addition, in the prior art products, a surface-deteriorated layer is formed by carrying out, after having formed the Dy film, the heat treatment for diffusion. If this surface-deteriorated layer is removed by machining, the oxygen content near the surface of the magnet can be seen to increase. In the case of the product of this invention, on the other hand, it can be seen that there does not exist the surface-deteriorated layer (the magnet surface is not of a ground surface), and that oxygen is uniformly present within the magnet (there does not locally exist a portion where the oxygen concentration is high) (see FIG. 5(g)). Further, according to the prior art products, since the surface of the magnet is enriched with Dy, dark portions and light portions can be recognized in the distribution of Nd within the magnets. In the products of this invention, on the other hand, it can be seen that Nd is substantially uniformly distributed within the magnets (see FIG. 5(d)).

In the above-described embodiment of this invention, a description has been made of an example in which, as the spacers 8, the supporting pieces 9 are formed integrally with an arrangement formed by assembling the wire materials into a lattice shape. Without being limited thereto, anything will do as long as the evaporated metal atoms are allowed to pass through; e.g., so-called expanded metal may be used.

Further, although a description has been made of an example in which the metal evaporating materials v are formed into a plate shape, they need not be limited thereto. Alternatively, an arrangement may be made such that on an upper surface of the sintered magnets S disposed on the spacers, another spacer is disposed so that the metal evaporating materials v in particulate form may be spread on the spacers (see FIG. 7). In addition, after having disposed the spacer 8 constituted by assembling the wire materials into a lattice shape on the metal evaporating materials v of plate shape, a plurality of sintered magnets S are placed in line with one another on the spacer 8. Another spacer 8 of the same constitution is disposed on top of the sintered magnets. Still another metal evaporating material v in plate shape is placed thereon. In this manner, the members are stacked on top of another up to the upper end of the processing box 7 (see FIG. 8). According to this arrangement, the amount of mounting of the sintered magnets S in the processing box 7 can further be increased. At this time, height-adjusting jigs made up of cylindrical bodies of Mo make may be vertically disposed between the metal evaporating material v and the spacers 8. The spacing between the plate-shaped metal evaporating material v and the upper surface of the sintered magnets S can thus be adjusted.

Further, in the above embodiment of this invention, a description has been made of an example in which Dy is used as the metal evaporating materials. In stead, there may be used Tb which is low in vapor pressure in a range of temperature of heating the sintered magnets S at which an appropriate diffusion speed can be accelerated. In this case, the processing chamber 70 may be heated in a range of 900˜1150° C. At a temperature below 900° C., the vapor pressure will not be reached at which the Tb atoms can be supplied to the surfaces of the sintered magnets S. At a temperature above 1150° C., on the other hand, Tb will be excessively diffused into the crystal grains, resulting in lowering in the maximum energy product and remanent magnetic flux density.

Further, in order to remove the stains, gases and moisture content adsorbed on the surfaces of the sintered magnets S before Dy or Tb is diffused into the grain boundaries and/or grain boundary phases, the following may be carried out, i.e., the vacuum chamber 12 is reduced to a predetermined pressure (e.g., 1×10⁻⁵ Pa) by means of the evacuating means 11 and, after the processing chamber 70 has been reduced to a pressure which is higher than the pressure in the vacuum chamber 12 by substantially half a digit (e.g., 5×10⁻⁴ Pa), this state is maintained for a predetermined period of time. At this time, the heating means 4 may be operated to heat the processing chamber 70 to, e.g., 300° C. and maintain this state for a predetermined period of time.

Further, in the above-described embodiment of this invention, a description has been made of an arrangement in which the lid portion 72 is mounted on the upper surface of the box portion 71 to thereby constitute the processing box 7. However, without being limited thereto, anything will do as long as the processing box 7 is isolated from the vacuum chamber 3 and, accompanied by the pressure reduction in the vacuum chamber 3, the processing chamber 70 is reduced in pressure. For example, after having housed the metal evaporating materials v and the sintered magnets S into the box portion 71, the upper opening thereof may be covered by a thin, e.g., of Mo make. On the other hand, an arrangement may also be made, e.g., such that the processing chamber 70 can be hermetically closed inside the vacuum chamber 3, whereby a predetermined pressure can be maintained therein independent of the vacuum chamber 3.

In the above-described embodiment of this invention, a description has been made of an example in which the sintered magnets S and the metal evaporating materials v are housed inside the processing box 7. However, the following arrangement may be made so as to enable to heat the sintered magnets S and the metal evaporating materials v at different temperatures. For example, the vacuum chamber is provided therein with an evaporating chamber (another processing chamber; not illustrated) aside from the processing chamber, and another heating means for heating the evaporating chamber is provided. After having evaporated the metal evaporating materials in the evaporating chamber, the metal atoms in the vapor atmosphere are supplied to the sintered magnets inside the processing chamber through a communication passage which brings the processing chamber and the evaporating chamber into communication with each other. In this case, an arrangement may be made such that, while the metal evaporating materials are being evaporated, the inert gas may be introduced into the processing chamber in which the sintered magnets are disposed.

As the sintered magnets S, the smaller the amount of oxygen content, the faster the speed of diffusion of Dy or Tb into the grain boundaries and/or grain boundary phases. Therefore, the oxygen content of the sintered magnets S themselves may be below 3000 ppm or preferably below 2000 ppm, or more preferably below 1000 ppm.

### Example 1

In Example 1, by using the vacuum vapor processing apparatus 1 as shown in FIG. 2, the following sintered magnets S were subjected to vacuum vapor processing to thereby obtain permanent magnets M. As the sintered magnets S, with industrial pure iron, metallic neodymium, low-carbon ferroboron, electrolysis cobalt, and pure copper as raw materials, the mixing composition (weight %) was arranged to be 25Nd-7Pr-1B-0.05Cu-0.05Ga-0.05Zr-Bal Fe (Sample 1), 7Nd-25Pr-1B-0.03Cu-0.3Al-0.1Nb-Bal Fe (Sample 2), 28Nd-1B-0.05Cu-0.01Ga-0.02Zr-Bal Fe (Sample 3), 27Nd-2Dy-1B-0.05Cu-0.05Al-0.05Nb-Bal Fe (Sample 4), 29Nd-0.95B-0.01Cu-0.02V, 0.02Zr-Bal Fe (Sample 5), 32Nd-1.1B-0.03Cu-0.02V-0.02Nb-Bal Fe (Sample 6), and 32Nd-1.1B-0.03Cu-0.02V-0.02Nb-Bal Fe (Sample 7). These samples were subjected to vacuum induction melting, and thin-piece ingots of about 0.3 mm thick were obtained by strip casting method. Then, they were once coarsely ground by hydrogen grinding process and subsequently finely ground by, e.g., a jet mill fine grinding process, thereby obtaining an alloy raw meal powder.

Then, by using a transverse magnetic field compression molding apparatus whose construction is known in the art, molded bodies were obtained and, subsequently, they were sintered in a vacuum sintering furnace at 1050° C. for 2 hours, thereby obtaining sintered magnets S. Then, by wire cutting method, the sintered magnets were machined to a shape of 2×40×40 mm, then they were subjected to finish machining to a surface roughness of below 10 μm, and then the surfaces were etched by diluted nitric acid.

Then, by using the vacuum vapor processing apparatus 1 as shown in FIG. 1, each group (each having ten magnets) of the sintered magnets S that were respectively manufactured as described above were subjected to vacuum vapor processing. In this case, by using Dy (99%) formed into a plate shape of 0.5 mm thick as the metallic evacuating materials v, the metallic evacuating materials v and the sintered magnets S were housed into the processing box 7 of W make. Then, after the pressure inside the vacuum chamber 3 has reached 10⁻⁴ Pa, the heating means 4 was operated, and the above-described processing was carried out by setting the temperature inside the processing chamber 70 to 800˜950° C. and the processing time to 3˜15 hours.

FIG. 9 is a table showing the magnetic properties (measured by a BH curve tracer) and processing conditions of the best values when permanent magnets were obtained by varying: the spacing between the sintered magnets S and the metal evaporating materials v inside the processing box 2; the kind of inert gases to be introduced during the vacuum vapor processing; and the partial pressures of the inert gases at that time, thereby obtaining the most appropriate processing conditions. Here, the ratio of squareness (%) in the table represents the magnitude of demagnetizing field required for the magnetization value to decrease to a certain ratio in the second quadrant (lower right quadrant) of the square demagnetization curve. In this example, Hk (“Hk value” is the same hereinafter) means the magnitude of magnetizing field when reduced by 10% and is represented by percentage of Hk/iHc.

According to this arrangement, in case the spacing between the sintered magnets S and the metal evaporating materials v inside the processing box 7 is set to 10 mm, it can be seen that the coercive force (iHc) was made higher when the inert gas was not introduced. On the other hand, if the above-described spacing becomes 5 mm or less, the maximum energy product exhibiting the magnetic properties was about one-half in case the vacuum vapor processing was carried out without introducing the inert gas, and the squareness ratio became 74% or less. Contrary to the above, it can be seen that a high squareness ratio of above 98% was obtained if a predetermined inert gas was appropriately introduced. As a result, in order to increase an amount of mounting the sintered magnets S to thereby increase the feasibility of mass production, the introduction of the inert gas can be seen effective.

### Example 2

In Example 2, by using the vacuum vapor processing apparatus 1 as shown in FIG. 2, the sintered magnets S that were manufactured in the same manner as the sample 6 in Example 1 were subjected to vacuum vapor processing. There were, however, prepared samples of the thicknesses of the sintered magnets respectively of 1, 3, 5, 10, 15 and 20 mm. On the spacers ten sintered magnets and Dy (99.5%) that was formed into a plate shape of 0.5 mm thick were stacked in the vertical direction, and were housed into the processing box 7 of W make. At this time, cylindrical bodies of Mo make were vertically disposed on four corners of the spacers so that the spacing between the metal evaporating materials v and the upper surface or the lower surface of the sintered magnets S could be adequately varied.

Next, as conditions at the time of vacuum vapor processing, after the pressure inside the vacuum chamber 3 has reached 10⁻⁵ Pa, the heating means 4 was operated, and the temperature inside the processing chamber 70 (vacuum vapor processing step) was set to 900° C., and the processing time (corresponding to the time for adjusting the amount of supply of the Dy atoms) to 5˜120 hours depending on the thickness of the sintered magnets. At this time, when the temperature inside the processing chamber 70 has reached 700° C., Ar gas was introduced into the processing chamber and, by varying the opening degree of the valve 11, the partial pressure of the Ar gas introduced into the vacuum chamber 3 was appropriately varied in a range of 500 Pa˜50 kPa, so that the above-described processing was carried out on each of the sintered magnets S. Finally, as the annealing step, heat treatment was carried out at 510° C. for 4 hours.

FIGS. 10(a) through 10(f) show the Hk values (k◯e) at the time when the permanent magnets were obtained by varying: the spacing between the sintered magnets S and the metal evaporating materials v inside the processing box 70; and the partial pressure of Ar gas. In FIG. 10, an asterisk mark (*) shows that, due to a large amount of supply of Dy, the sintered magnets and the spacers 8 on which vacuum vapor processing was performed got fused and adhered to each other, whereby measurement was impossible.

According to the above, it can be seen that, when the partial pressure of Ar gas is low, the rectilinear properties of Dy becomes strong and the Hk value becomes low irrespective of the thickness of the sintered magnets and, as a consequence, the squareness is poor. Further, upon visual confirmation of the permanent magnets after the vacuum vapor processing, irregularities in processing were recognized to have happened.

On the other hand, in the range of partial pressure of Ar gas of 1˜30 kPa, the amount of supply of Dy became excessive when the spacing between the sintered magnets and the plate-like Dy was 0.1 mm and, as a result, there was a disadvantage in that the spacers and the sintered magnets got adhered to each other. In the range of 0.3˜10 mm, on the other hand, it can be seen that Dy was supplied in an ideal manner, with the result that a high value above 16 k◯e was obtained, with a resultant good squareness. It can be seen that, when the partial pressure of Ar gas was 50 kPa, the amount of evaporation of Dy was restricted, whereby Dy atoms were not supplied to the surfaces of the sintered magnets. Further, it can be seen that, at the processing time exceeding 100 hours, it was impossible to obtain high-performance magnets even if the partial pressure of Ar gas was adjusted.

### Example 3

In Example 3, by using the vacuum vapor processing apparatus 1 as shown in FIG. 2, vacuum vapor processing was carried out on sintered magnets S. As the sintered magnets, there were prepared ones available on the market having the composition of 28.5(Nd+Pr)-3Dy-0.5Co-0.02Cu-0.1Zr-0.05Ga-1.1B-Bal. Fe, and 20×20×t mm (thickness t was 1.5 mm and 10 mm).

Then, after having disposed ten sintered magnets on a spacer, another spacer was placed on top of the above-described spacer, and a total weight of 5 g of Dy (99.5%) in particle form was disposed, thereby housing them into the processing box 7 of W make.

Then, as the conditions for the vacuum vapor processing, after the pressure inside the vacuum chamber 3 has reached 10⁻⁴ Pa, the heating means 4 was operated, and the temperature inside the processing chamber 70 (vacuum vapor processing step) was set to 900° C. After Dy has started evaporation, Ar gas was appropriately introduced into the vacuum chamber 3. At a pressure of 10⁻⁴ Pa˜50 kPa optimum vapor processing was each carried out and thereafter heat treatment (annealing step) was carried out at 510° C. for 4 hours.

FIGS. 11(a) through 11(h) show Hk values (k◯e) at the time when the permanent magnets were obtained by varying: the spacing between the sintered magnets S and the metal evaporating materials v inside the processing box; and the partial pressure of Ar gas to be introduced during the vacuum vapor processing. In FIG. 11, an asterisk mark (*) shows that, due to an increase in the amount of supply of Dy, the sintered magnets and the spacers 8 on which vacuum vapor processing was carried out got fused and adhered to each other, whereby measurement was impossible.

According to the above, it can be seen that, in the range of 1˜30 kPa, high-performance magnets can be obtained without impairing the squareness of demagnetization curve if the spacing between the sintered magnets S and the metal evaporating materials v falls within the range of 0.3˜10 mm (see FIGS. 11(b) through 11(f)).

### Example 4

In Example 4, by using the vacuum evaporating apparatus 1 as shown in FIG. 2, vacuum vapor processing was carried out on sintered magnets (30×40×5 mm thick) that were manufactured in a manner similar to that in Sample 6 in Example 1. On the spacer ten sintered magnets and Dy (99.5%) that was formed into a plate shape of a thickness of 0.5 mm were stacked in the vertical direction and were housed into the processing box 7 of W make.

Then, as conditions at the time of vacuum vapor processing, after the pressure inside the vacuum chamber 3 has reached 10⁻³ Pa, the heating means 4 was operated, and the temperature inside the processing chamber 70 (vacuum vapor processing step) was set to 875° C., and the processing time was set to 28 hours. At this time, when the temperature inside the processing chamber 70 has reached 875° C., Ar gas was introduced into the processing chamber at a partial pressure of 13 kPa. Thereafter, heat treatment was carried out at 510° C. for 4 hours (annealing step).

FIG. 12 shows average values of the magnetic properties (measured by BH curve tracer) when the pressure inside the vacuum chamber until the Ar gas was introduced was varied in the range of 0.5 Pa˜4×10⁻⁵ Pa by varying the opening degree of the valve 11. According to the above, it can be seen that, if the pressure inside the vacuum chamber until the Ar gas was introduced thereinto is kept below 10⁻² Pa, the magnetic properties are improved and that, if the pressure is further kept lower, there can be obtained permanent magnets with still higher magnetic properties.

### BRIEF DESCRIPTION OF THE DRAWINGS

FIG. 1 is a sectional view schematically showing a section of a permanent magnet manufactured according to this invention;

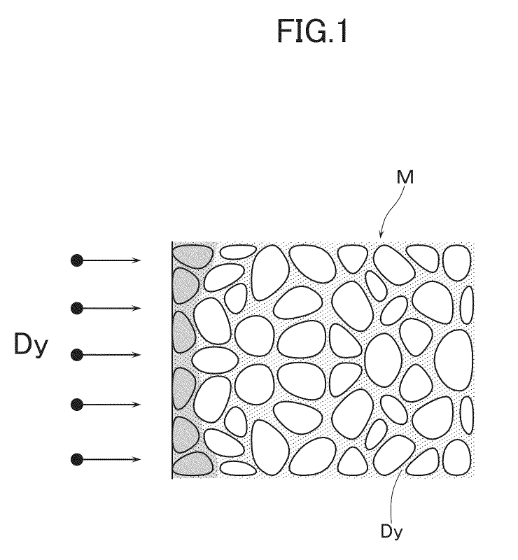

FIG. 2 is a sectional view schematically showing a vacuum processing apparatus for carrying out the processing according to this invention;

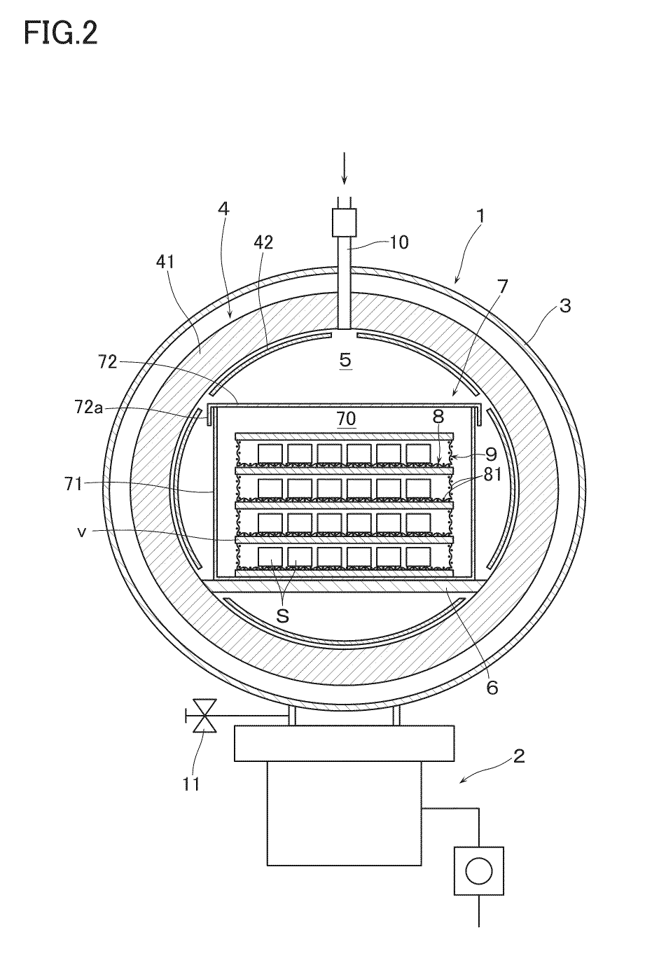

FIG. 3 is a perspective view schematically showing the mounting, into a processing box, of sintered magnets and metal evaporating materials;

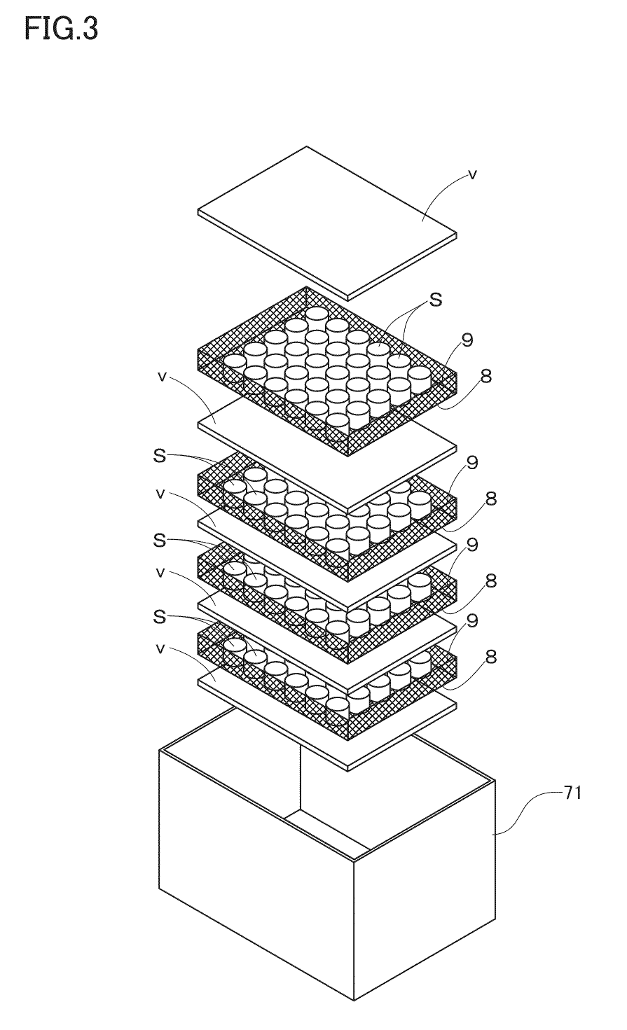

FIG. 4 is a graph showing the relationship between the introduction of an inert gas and heating temperature in the processing chamber at the time of vacuum vapor processing;

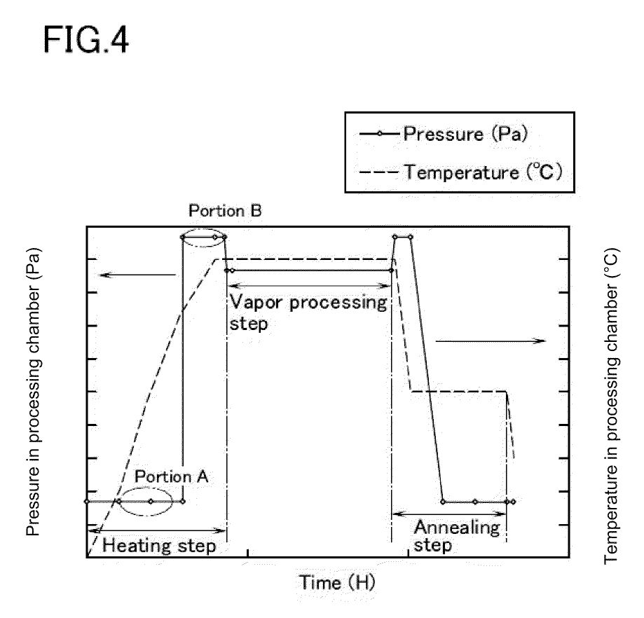

FIGS. 5(a) through 5(g) are SEM micrographs and EPMA micrographs near the surfaces of the magnets (of this invention) which were manufactured by subjecting sintered magnets to vacuum vapor processing and by forming Ni-plating layers on the surfaces of the permanent magnets;

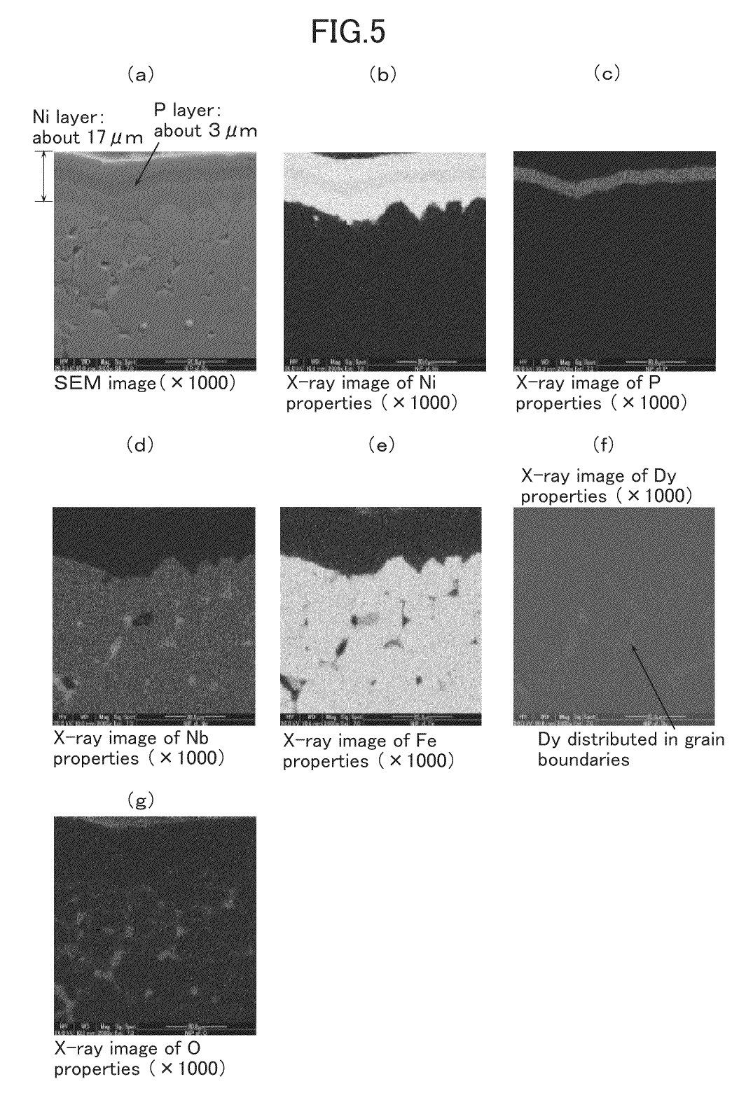

FIG. 6 is a graph showing the distribution of Dy from the surface of the permanent magnet in FIG. 4 toward the center thereof;

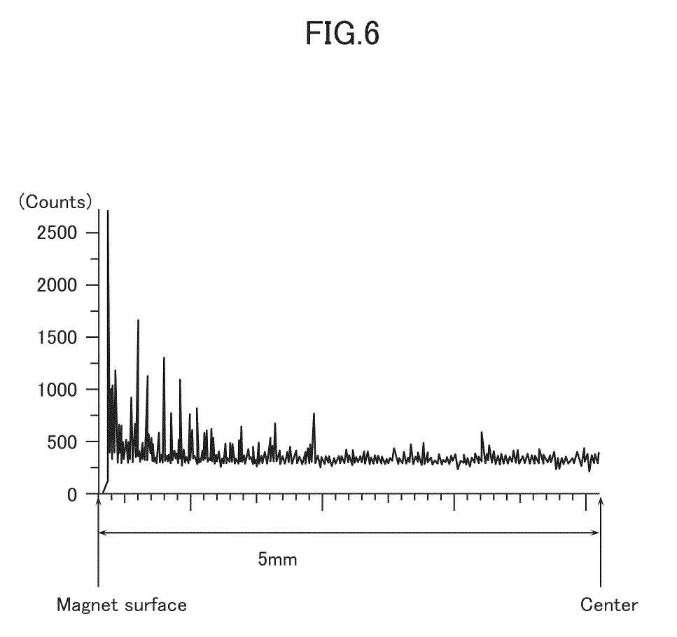

FIG. 7 is a perspective view schematically showing the mounting, into a processing box, of sintered magnets and metal evaporating materials according to a modified example of this invention;

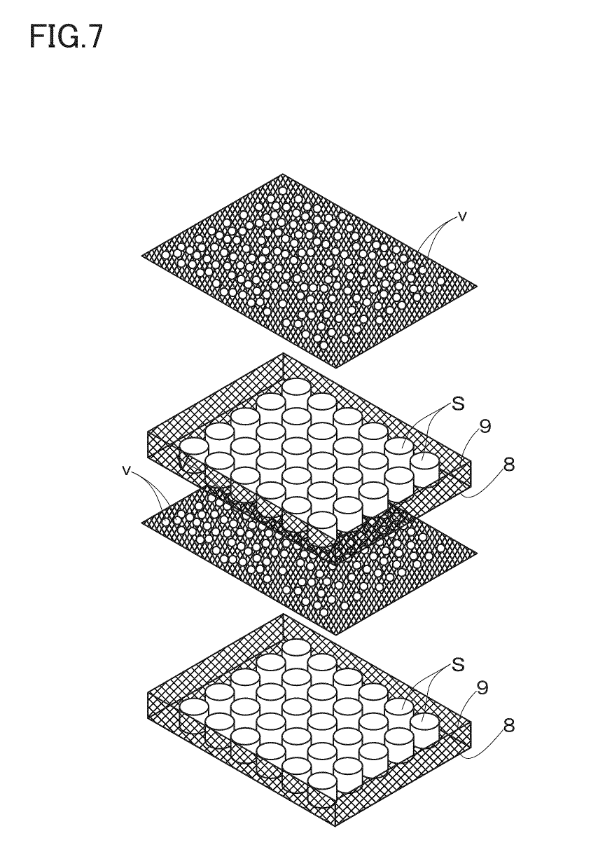

FIG. 8 is a perspective view schematically showing the mounting, into a processing box, of sintered magnets and metal evaporating materials according to another modified example of this invention;

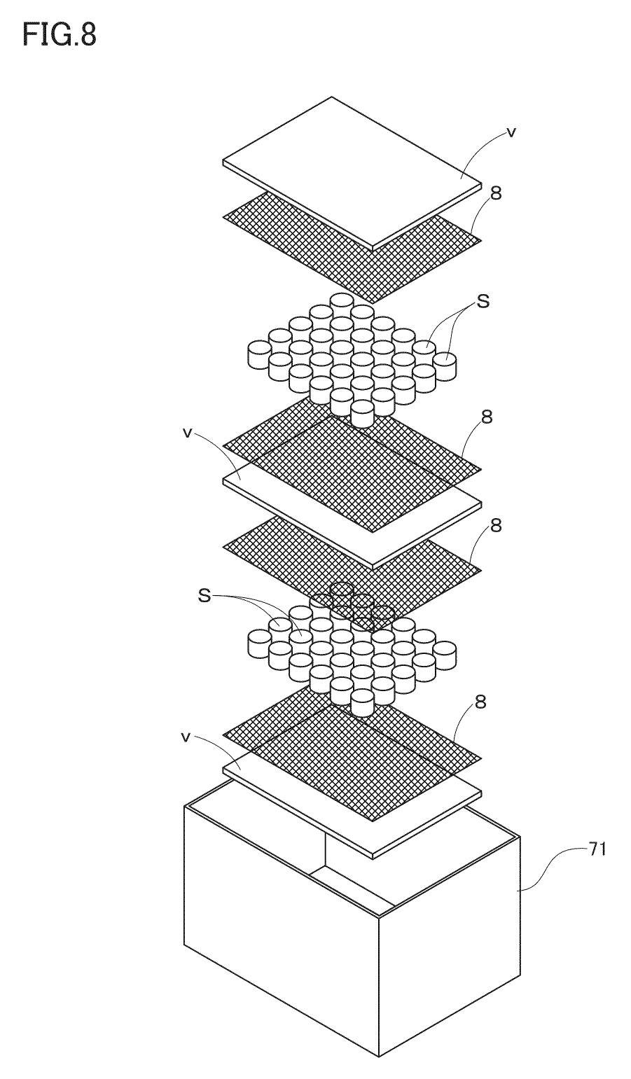

FIG. 9 is a table showing the magnetic properties of the permanent magnets manufactured in Example 1;

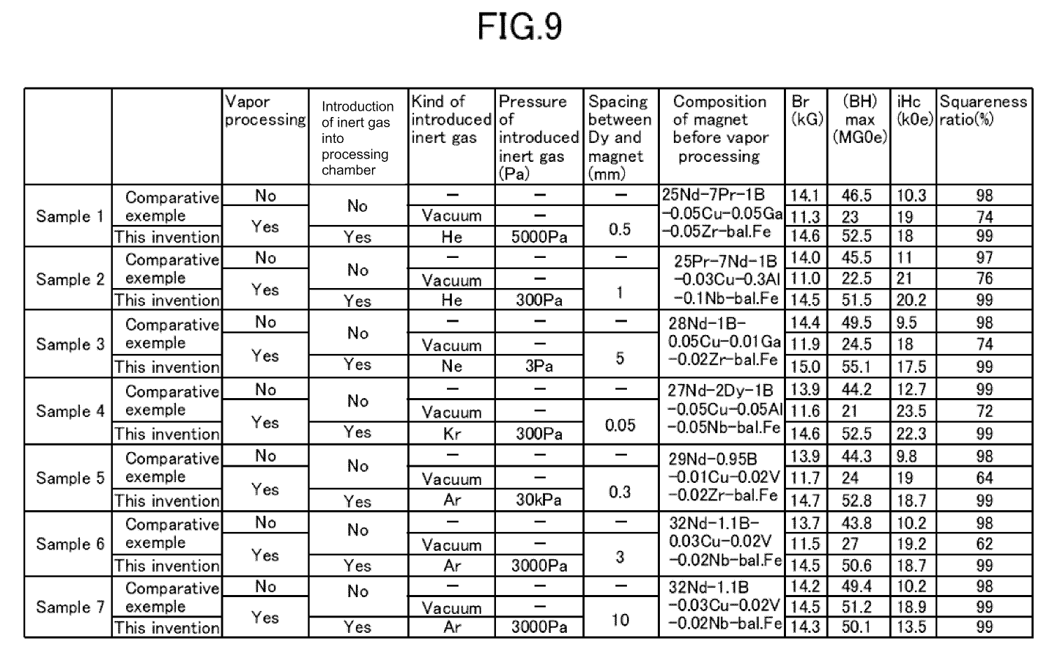

FIG. 10 is a table showing the magnetic properties (Hk values) of the permanent magnets manufactured in Example 2;

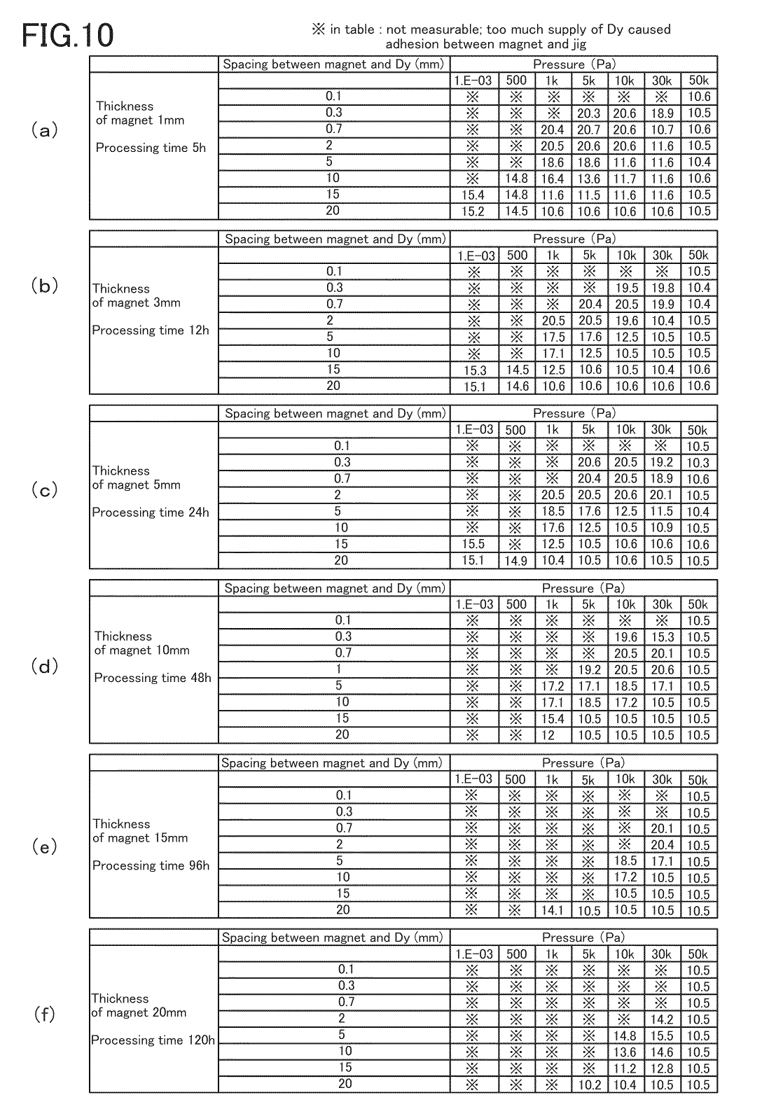

FIG. 11 is a table showing the magnetic properties (Hk values) of the permanent magnets manufactured in Example 3; and

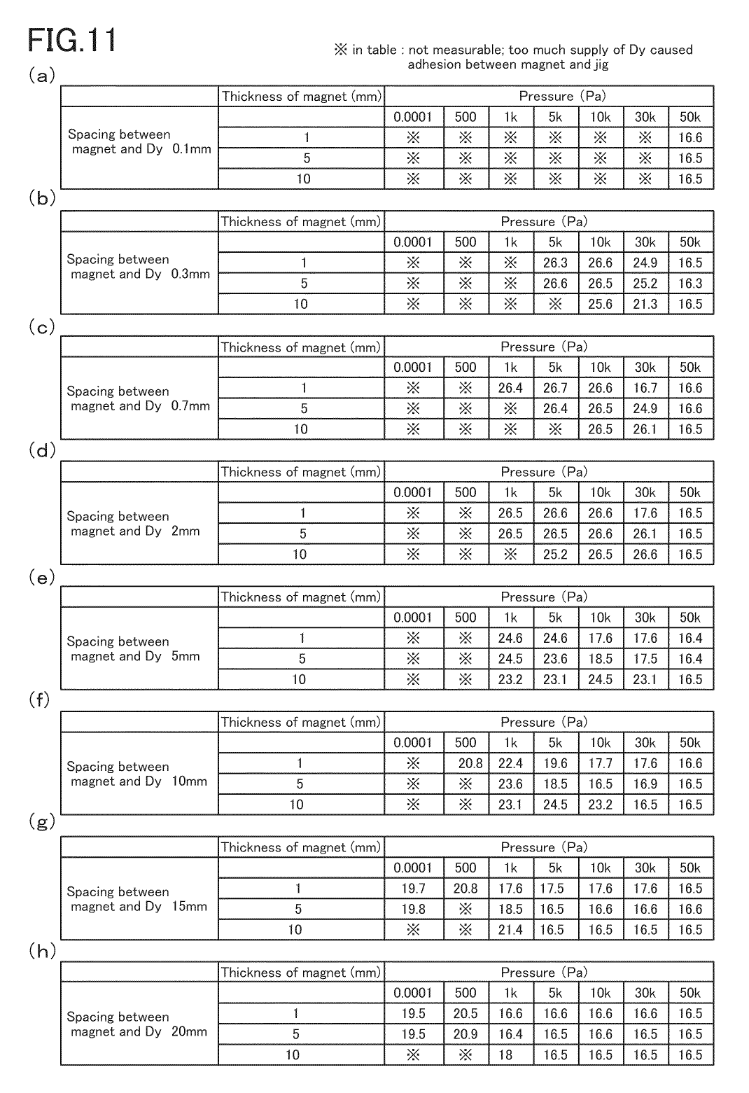

FIG. 12 is a table showing the magnetic properties of the permanent magnets manufactured in Example 4.

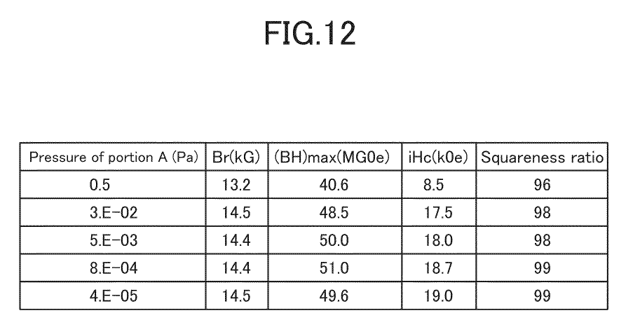

### DESCRIPTION OF REFERENCE NUMERALS AND CHARACTERS

1 vacuum vapor processing apparatus
2 evacuating means
3 vacuum chamber
4 heating means
7 processing box
71 box portion
72 lid portion
8 spacer
81 wire material
9 supporting piece
10 gas introduction pipe (gas introduction means)
11 valve
S sintered magnet
M permanent magnet
v metal evaporating material

1. A method of manufacturing a permanent magnet comprising:
heating an iron-boron-rare earth based sintered magnet disposed in a processing chamber to a predetermined temperature, and also evaporating a metal evaporating material containing at least one of Dy and Tb, the metal evaporating material being disposed in a same or another processing chamber;
adjusting a supply amount of thus evaporated metal atoms to a surface of the sintered magnet to adhere the metal atoms to the sintered magnet, and
diffusing the adhered metal atoms into grain boundaries and/or grain boundary phases of the sintered magnet,
wherein an inert gas is introduced into the processing chamber in which the sintered magnet is disposed, the inert gas being introduced while the metal evaporating material is being evaporated.

2. The method of manufacturing a permanent magnet according to claim 1, wherein, in a step of heating the sintered magnet to reach the predetermined temperature, the pressure in the processing chamber in which the sintered magnet is disposed, is maintained at 0.1 Pa or less before the inert gas is introduced.

3. The method of manufacturing a permanent magnet according to claim 1, wherein a partial pressure of the inert gas is varied to adjust the supply amount.

4. The method of manufacturing a permanent magnet according to claim 3, wherein the partial pressure of the inert gas in the processing chamber is in a range of 1˜30 kPa.

5. The method of manufacturing a permanent magnet according to claim 1, wherein the time of adjusting the supply amount is in a range of 4˜100 hours.

6. The method of manufacturing a permanent magnet according to claim 1, wherein, when the sintered magnet and the metal evaporating material are disposed in the same processing chamber, the sintered magnet and the metal evaporating material are disposed free from contact with each other.

7. The method of manufacturing a permanent magnet according to claim 6, wherein the spacing between the sintered magnet and the metal evaporating material is set to a range of 0.3˜10 mm.

8. The method of manufacturing a permanent magnet according to claim 6, wherein the spacing between the sintered magnet and the metal evaporating material is set to a range of 0.3˜2 mm.

9. The method of manufacturing a permanent magnet according to claim 1, further comprising, after having diffused the metal atoms into the grain boundary phases of the sintered magnet, carrying out heat-treatment at a given temperature which is lower than the said predetermined temperature.

10. A permanent magnet manufactured by using the method of manufacturing a permanent magnet according to claim 1, wherein the metal atoms are distributed into the grain boundaries and/or grain boundary phases in concentration which becomes thinner from the surface of the magnet toward a center thereof, wherein the metal atoms of at least one of Dy and Tb are uniformly present on the surface of the magnet, and wherein an oxygen concentration is uniform.
